(19) United States
(12) Patent Application Publication
(10) Pub. No.: US 2018/0141189 A1
(43) Pub. Date: May 24, 2018

(54) Driving Tool Adapted to be Used at an Angle Off-Axis to Object to be Driven

(71) Applicant: Hong Ann Tool Industries Co., Ltd., Taichung City (TW)

(72) Inventor: Cheng-Wei Su, Taichung City (TW)

(21) Appl. No.: 15/805,212

(22) Filed: Nov. 7, 2017

(30) Foreign Application Priority Data
Nov. 23, 2016 (TW) 105138407

(51) Int. Cl. B25B 15/00; B25B 23/00

(52) U.S. Cl. CPC B25B 15/008; B25B 23/0028

(57) ABSTRACT

A driving tool adapted to be used at an angle off-axis to an object to be driven has a main body and a driving head connected to an end of the main body and integrally formed as a one-piece structure. The driving head has a working portion for driving the object. The working portion has a non-circular cross section and defines circumferentially alternating lobes and depressions. The driving head has a second distal end opposite the first distal end and forms a conical portion which tapers from the working portion to the second distal end. The driving head has a top surface at the second distal end and contiguous with the conical portion. The conical portion and the top surface have an included angle greater than 90 degrees and less than 180 degrees.

### BACKGROUND OF THE INVENTION

### 1. Field of the Invention

The present invention relates to a driving tool and, particularly, to a driving tool which is adapted to be used at an angle off-axis to an object to be driven.

### 2. Description of the Related Art

TW Pat. No. M431772 shows a hex tool adapted to drive an object at an angle off-axis to the object. The hex tool has a hexagonal shank portion, a ball portion, and a reduced diameter neck portion joining the hexagonal shank and the ball. The ball portion has six curved surfaces. The neck portion has a circular cross section. When the hex tool is used at an angle off-axis to the object, it does not allow large torque to be applied. The present invention is, therefore, intended to obviate or at least alleviate the problems encountered in the prior art.

### SUMMARY OF THE INVENTION

According to the present invention, a driving tool adapted to be used at an angle off-axis to object to be driven has a main body. A driving head has a first distal end connected to an end of the main body and integrally formed as a one-piece structure. The driving head has a longitudinal center axis. The driving head has a working portion for driving the object. The working portion has a non-circular cross section and defines circumferentially alternating lobes and depressions about the center axis. The driving head has a second distal end opposite the first distal end and forms a conical portion which tapers from the working portion to the second distal end. The driving head has a top surface at the second distal end and contiguous with the conical portion. The conical portion and the top surface have an included angle greater than 90 degrees and less than 180 degrees. The working portion abuts the object when the driving tool drives the object in an angular relationship with respect to an axis of the object.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the public generally, and especially the scientists, engineers and practitioners in the art who are not familiar with patent or legal terms or phraseology, to determine quickly from a cursory inspection the nature and essence of the technical disclosure. The abstract is neither intended to define the invention, which is measured by the claims, nor is it intended to be limiting as to the scope of the invention in any way.

Other objectives, advantages, and new features of the present invention will become apparent from the following detailed description of the invention when considered in conjunction with the accompanied drawings.

### BRIEF DESCRIPTION OF THE DRAWINGS

FIG. 1 is a perspective view of a driving tool which is adapted to be used at an angle off-axis to an object to be driven in accordance with a first embodiment of the present invention.

FIG. 2 is a side view illustrating the driving tool of FIG. 1 engaging with an object, with the driving tool axis aligned with the object axis.

FIG. 3 is a cross-sectional view taken along line 3-3 of FIG. 2.

FIG. 4 is an extended side view of FIG. 2 illustrating the driving tool engaging with the object at an angle with respect to the object axis.

FIG. 5 is a cross-sectional view taken along line 5-5 of FIG. 4.

FIG. 6 is a perspective view of a driving tool which is adapted to be used at an angle off-axis to the object to be driven in accordance with a second embodiment of the present invention.

FIG. 7 is a perspective view of a driving tool which is adapted to be used at an angle off-axis to the object to be driven in accordance with a third embodiment of the present invention.

### DETAILED DESCRIPTION OF THE INVENTION

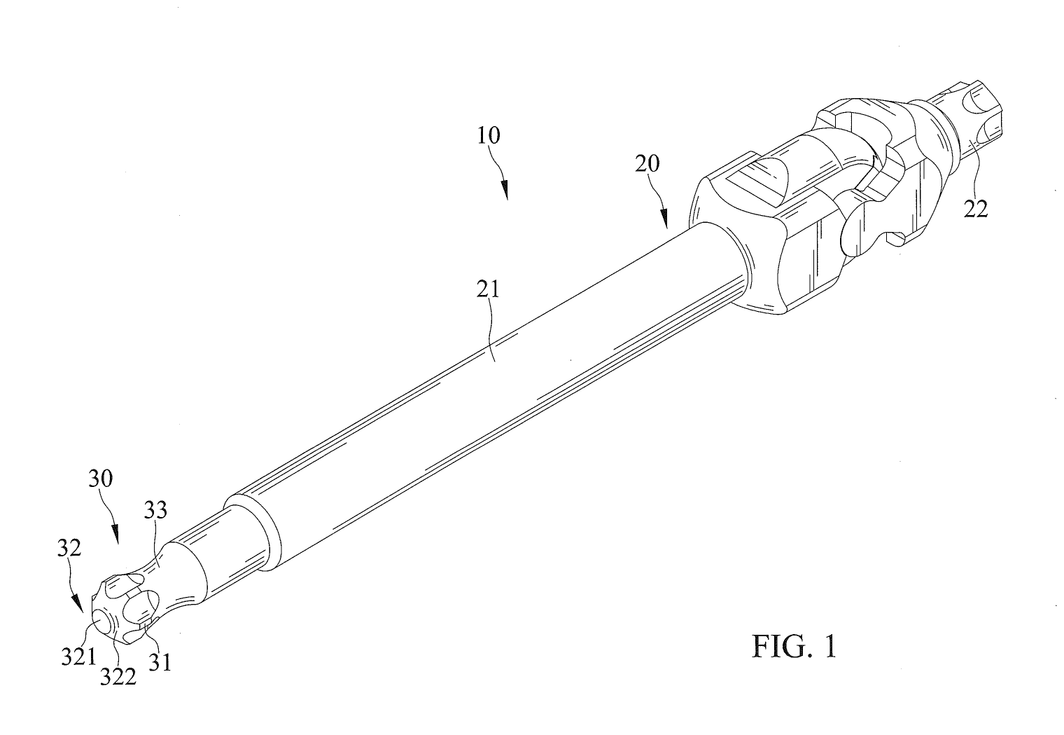

FIGS. 1 through 5 show a driving tool 10 which is adapted to be used at an angle off-axis to an object 90 to be driven in accordance with a first embodiment of the present invention. The object 90 is a screw and has an axis of rotation C. The driving tool 10 has a main body 20 and a driving head 30.

The driving head 30 has a first distal end connected to a first end of the main body 20 and integrally formed as a one-piece structure. The driving head 30 has a longitudinal center axis L. The driving head 30 has a working portion 31 for driving the object 90. The working portion 31 has a non-circular cross section and defines circumferentially alternating lobes and depressions about the center axis L. Preferably, the working portion 31 has a polygonal cross section transverse to the center axis L. Preferably, the working portion 31 has six lobes. Each of the lobes and depressions of the working portion 31 does not extend to the second distal end of the driving head 30. Each of the lobes has a flat peak edge.

The driving head 30 forms a conical portion. The driving head 30 has a second distal end opposite the first distal end. The conical portion tapers from the working portion 31 to the second distal end. The driving head 30 has a top end 32 at the second distal end. The driving head 30 has a top surface 321 at the second distal end and contiguous with the conical portion. The conical portion and the top surface 321 have an included angle greater than 90 degrees and less than 180 degrees. The top surface 321 is a flat surface. The conical portion has an outer surface 322. The outer surface 322 is sloped and tapers from an end contiguous with the working portion 31 to another end contiguous with the top surface 321.

The driving head 30 also forms a neck portion 33. The neck portion 33 has an inwardly curved outer surface. The neck portion 33 has a first end connected to the first distal end of the main body 20 with a first width transverse to the center axis L, a second end connected to the working portion 31 with a second width transverse to the center axis L, and a middle between the first and second ends with a third width transverse to the center axis L. The third width is smaller than the first and second widths. The working portion 31 has a greatest width transverse to the center axis L. The first and second widths are not greater than the greatest width. The main body 20 has a smallest width transverse to the center axis L greater than the first width.

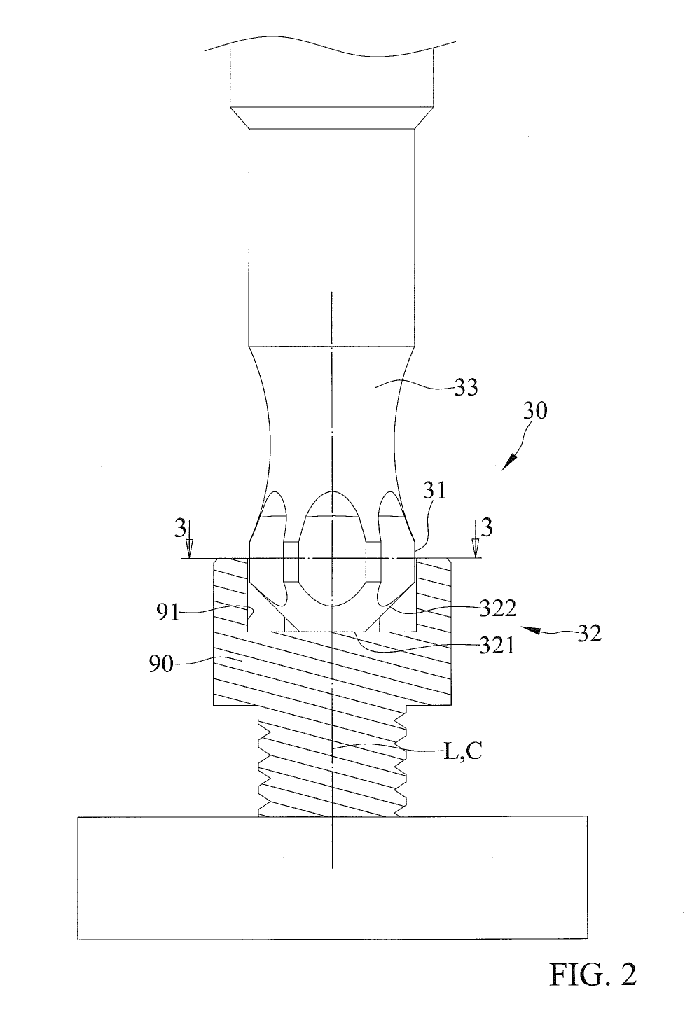

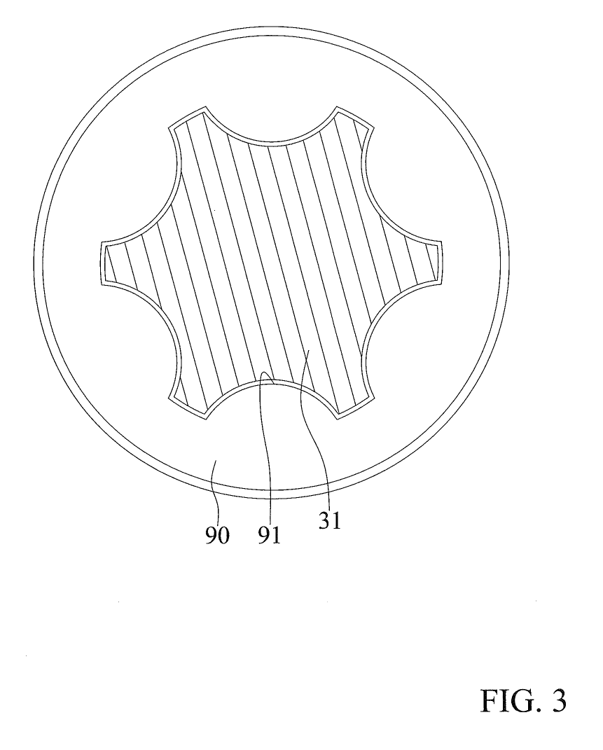

FIGS. 2 and 3 show the driving tool 10 engages with the object 90 in an aligned relationship with the axis of rotation C of the object 90. Thus, the center axis L of the driving head 30 is aligned with the axis of rotation of the object 90. The driving tool 10 includes the working portion 31 engaging with a peripheral wall of an engaging hole 91 of the object 90. The working portion 31 includes six lobes engaging with the peripheral wall of the engaging hole 91. The flat peak edges of the lobes will abut the peripheral wall of the engaging hole 91 in surface contact when the object 90 is operably rotated by the driving tool 10. Furthermore, the top surface 321 will abut a bottom edge of the engaging hole in surface contact when the object 90 is operably rotated by the driving tool 10. In addition, the conical outer surface 322 avoids contact with the peripheral wall of the engaging hole 91.

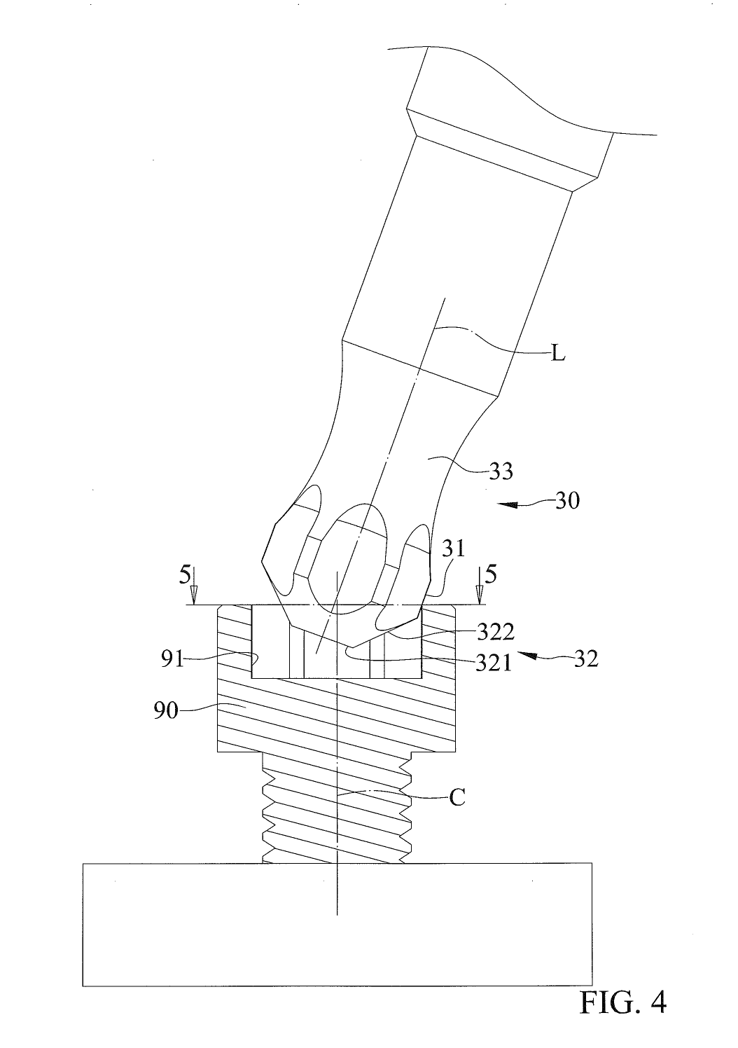

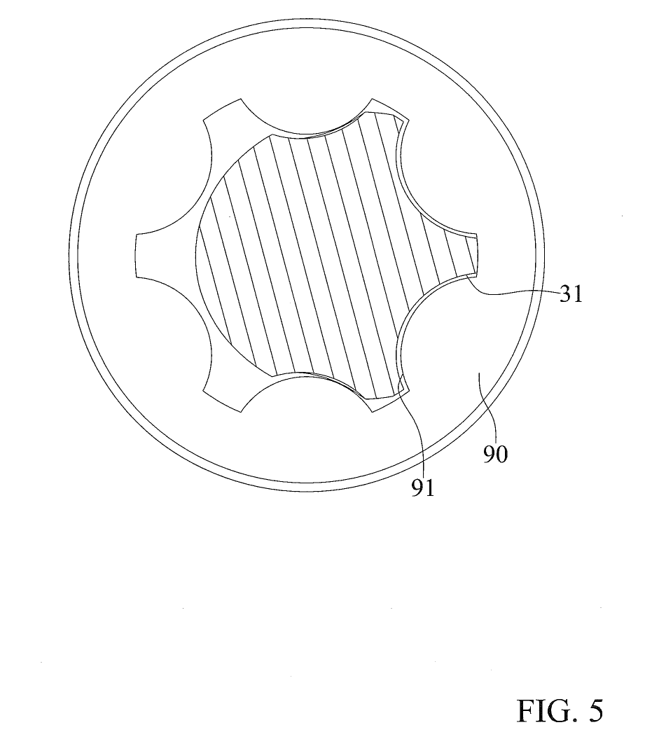

FIGS. 4 and 5 show the driving tool 10 engages with the object 90 in an angular relationship with respect to the axis of rotation C of the object 90. Preferably, an angle between the center axis L of the driving head 30 is and the axis of rotation C of the object 90 is in range of 0 to 30 degrees. The driving tool 10 includes the working portion 31 engaging with the peripheral wall of an engaging hole 91 of the object 90. The working portion 31 includes three lobes engaging with the peripheral wall of the engaging hole 91. The flat peak edges of the lobes will abut the peripheral wall of the engaging hole 91 in surface contact when the object 90 is operably rotated by the driving tool 10. Consequently, the driving tool 10 can effectively drive the object 90. Another advantage is that the working portion 31 of the driving tool 10 does not disengage from the engaging hole 91 of the object 90 easily. Furthermore, the top surface 321 will abut a bottom edge of the engaging hole in surface contact when the object 90 is operably rotated by the driving tool 10. In addition, the conical outer surface 322 avoids contact with the peripheral wall of the engaging hole 91.

Furthermore, the neck portion 33 of the driving head 30 does not abut the object 90, as shown in FIGS. 2 and 4.

The driving tool 10 further comprising another driving head connected to a second end of the main body 20 and integrally formed as a one-piece structure. Another driving head has a non-circular cross section. Another driving head defines circumferentially alternating lobes and depressions. Another driving head has a flat surface at a distal end. Each of the lobes and depressions of another driving head extends to the flat surface.

The main body 20 has a first body portion 21 and a second body portion 22 pivotally connected to the first body portion 21. Each of the first and second body portions 21 and 22 has a first end and a second end. The driving head 30 is connected to the first end of the first body portion 21. The second end of the first body portion 21 is pivotally connected to the first end of the second body portion 22. The second body portion 22 is rotatable through an angle of 180 degrees relative to the first body portion 21.

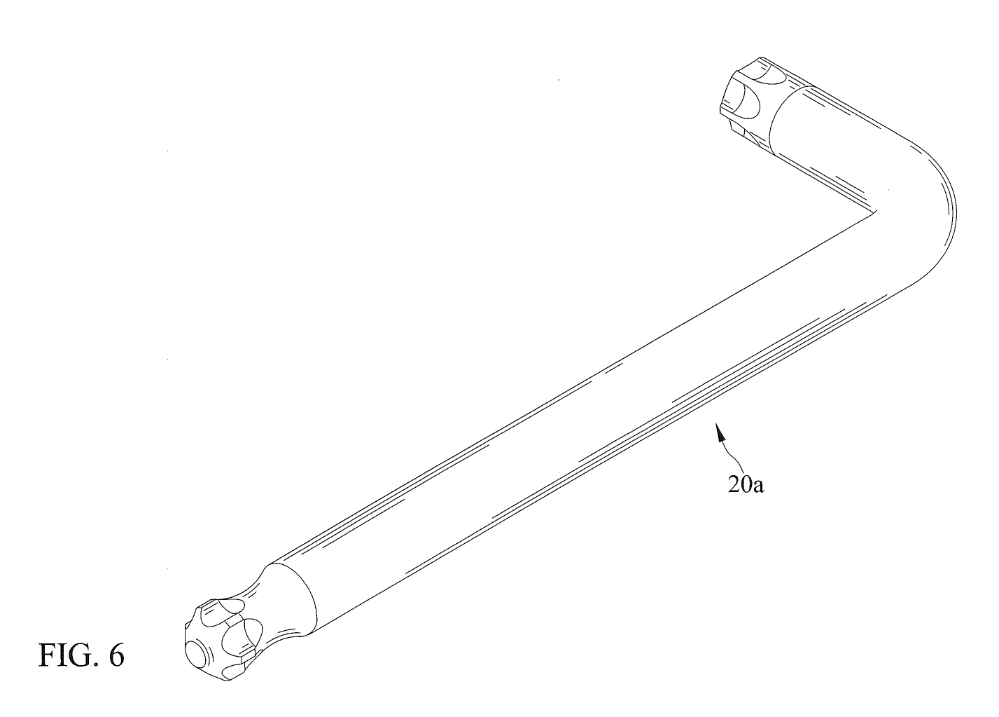

FIG. 6 shows a driving tool which is adapted to be used at an angle off-axis to the object 90 to be driven in accordance with a second embodiment of the present invention, and the same numbers are used to correlate similar components of the first embodiment, but bearing a letter a. The second embodiment differentiates from the first embodiment in that the main body 20a is L shaped, and the main body 20a is a one-piece structure.

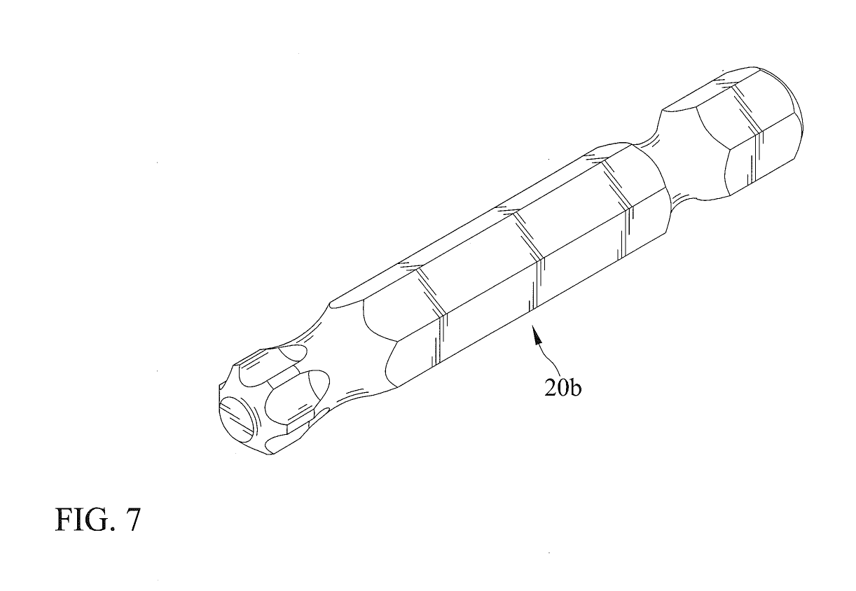

FIG. 7 shows a driving tool which is adapted to be used at an angle off-axis to the object 90 to be driven in accordance with a second embodiment of the present invention, and the same numbers are used to correlate similar components of the first embodiment, but bearing a letter b. The third embodiment differentiates from the second embodiment in that the main body 20b is I shaped. In addition, another driving head has a hexagonal cross section.

In view of the forgoing, it is easy to manufacture the conical portion of the driving head 30. The driving tool 10 can effectively drive, i.e. rotate, the object 90 in an angular relationship with respect to the axis of rotation C of the object 90 in that the working portion 31 includes three lobes engaging with the peripheral wall of the engaging hole 91 and the flat peak edges of the lobes abut the peripheral wall of the engaging hole 91 in surface contact when the object 90 is operably rotated by the driving tool 10.

The foregoing is merely illustrative of the principles of this invention, and various modifications can be made by those skilled in the art without departing from the scope and spirit of the invention.

What is claimed is:

1. A driving tool which is adapted to be used at an angle off-axis to an object to be driven comprising:
a main body, a driving head having a first distal end connected to a first end of the main body and integrally formed as a one-piece structure, wherein the driving head has a longitudinal center axis, wherein the driving head has a working portion for driving the object, wherein the working portion has a non-circular cross section and defines circumferentially alternating lobes and depressions about the center axis, wherein the driving head has a second distal end opposite the first distal end and forms a conical portion which tapers from the working portion to the second distal end, wherein the driving head has a top surface at the second distal end and contiguous with the conical portion, and wherein the conical portion and the top surface have an included angle greater than 90 degrees and less than 180 degrees.

2. The driving tool as claimed in claim 1, wherein the driving head forms a neck portion having an inwardly curved outer surface, with the neck portion having a first end connected to the first distal end of the main body with a first width transverse to the center axis, a second end connected to the working portion with a second width transverse to the center axis, and a middle between the first and second ends with a third width transverse to the center axis, with the third width smaller than the first and second widths, with the working portion having a greatest width transverse to the center axis, with the first and second widths not greater than the greatest width, and with the main body having a smallest width transverse to the center axis greater than the first width.

3. The driving tool as claimed in claim 1, wherein each of the lobes has a flat peak edge.

4. The driving tool as claimed in claim 1, wherein the working portion has a polygonal cross section transverse to the center axis.

5. The driving tool as claimed in claim 1, wherein the top surface is a flat surface.

6. The driving tool as claimed in claim 1 further comprising another driving head connected to a second end of the main body and integrally formed as a one-piece structure, wherein another driving head has a non-circular cross section.

7. The driving tool as claimed in claim 6, wherein another driving head defines circumferentially alternating lobes and depressions, wherein another driving head has a flat surface at a distal end, and wherein each of the lobes and depressions of another driving head extends to the flat surface.

8. The driving tool as claimed in claim 1, wherein the main body has a first body portion and a second body portion pivotally connected to the first body portion, with each of the first and second body portions having a first end and a second end, with the driving head connected to the first end of the first body portion, and with the second end of the first body portion pivotally connected to the first end of the second body portion, and wherein the second body portion is rotatable through an angle of 180 degrees relative to the first body portion.

9. The driving tool as claimed in claim 1, wherein the main body is L shaped.

10. The driving tool as claimed in claim 1, wherein the main body is I shaped.

11. The driving tool as claimed in claim 3, wherein the driving head forms a neck portion having an inwardly curved outer surface, with the neck portion having a first end connected to the first distal end of the main body with a first width transverse to the center axis, a second end connected to the working portion with a second width transverse to the center axis, and a middle between the first and second ends with a third width transverse to the center axis, with the third width smaller than the first and second widths, with the working portion having a greatest width transverse to the center axis, with the first and second widths not greater than the greatest width, and with the main body having a smallest width transverse to the center axis greater than the first width.

12. The driving tool as claimed in claim 11, wherein each of the lobes of the working portion has a flat peak edge.

13. The driving tool as claimed in claim 12, wherein the top surface is a flat surface.

14. The driving tool as claimed in claim 13 further comprising another driving head connected to a second end of the main body and integrally formed as a one-piece structure, wherein another driving head has a non-circular cross section.

15. The driving tool as claimed in claim 14, wherein another driving head defines circumferentially alternating lobes and depressions, wherein another driving head has a flat surface at a distal end, and wherein each of the lobes and depressions of another driving head extends to the flat surface.
